(19) United States
(12) Patent Application Publication
(10) Pub. No.: US 2025/0245596 A1
(43) Pub. Date: Jul. 31, 2025

(54) METHOD AND DEVICE FOR DETERMINING FLOOD-DIVERSION STRATEGY OF FLOOD STORAGE AND DETENTION BASIN BASED ON BALANCED PERSPECTIVE, MEDIUM, AND PRODUCT

(71) Applicant: CHINA THREE GORGES UNIVERSITY, Yichang City, Hubei (CN)

(72) Inventors: Changwen LI, Yichang City (CN); Jiale HUANG, Yichang City (CN); Rui ZHOU, Yichang City, Hubei (CN); Sujing LIN, Yichang City (CN); Liting YANG, Yichang City (CN); Feihan LI, Yichang City (CN); Zhiwei LI, Yichang City (CN); Jiaqi ZHU, Yichang City (CN); Jiarui LI, Yichang City (CN); Xiaoxia ZENG, Yichang City (CN); Yalan YANG, Yichang City (CN); Congliang WANG, Yichang City (CN); Changyin DU, Yichang City (CN); Junxian LIN, Yichang City (CN); Mengdi XU, Yichang City (CN); Yu PAN, Yichang City (CN); Shuangqin CHEN, Yichang City (CN); Shiya WANG, Yichang City (CN); Jiarui SONG, Yichang City (CN); Yujia SONG, Yichang City (CN); Xiaolu WEI, Yichang City (CN); Jierui ZHANG, Yichang City (CN); Jingyao LI, Yichang City (CN); Qibo DENG, Yichang City (CN); Zichao SHEN, Yichang City (CN); Weiqi ZHANG, Yichang City (CN); Wendi WANG, Yichang City (CN)

(21) Appl. No.: 18/950,915

(22) Filed: Nov. 18, 2024

(30) Foreign Application Priority Data
Jan. 31, 2024 (CN) 202410138881.7

(51) Int. Cl. G06Q 10/0637; G06Q 50/06

(52) U.S. Cl. CPC G06Q 10/0637; G06Q 50/06

(57) ABSTRACT

A method and device for determining a flood-diversion strategy of a flood storage and detention basin based on a balanced perspective is provided. The method includes determining excess flood peaks and excess flood amounts of middle and downstream main streams in a preset time period after scheduling and enabling of a reservoir group in each river section. A correlation map between a flood-diversion amount and a flood-diversion water-level reduction value under each set flood-diversion parameter combination is then constructed. Enabling priorities and flood-diversion volumes for all flood storage and detention basins in all river sections are determined. A cumulative flood-diversion volume of each flood storage and detention basin is also determined. A flood storage and detention basin-enabling knowledge map is constructed and a plurality of flood-diversion plans are determined. A flood-diversion plan from the plurality of flood-diversion plans is then selected as a target plan to allow flood diversion.

### CROSS REFERENCE TO RELATED APPLICATION

This patent application claims the benefit and priority of Chinese Patent Application No. 202410138881.7, filed with the China National Intellectual Property Administration on Jan. 31, 2024, the disclosure of which is incorporated by reference herein in its entirety as part of the present application.

### TECHNICAL FIELD

The present disclosure relates to the technical field of flood-diversion management, and in particular to a method and device for determining a flood-diversion strategy of a flood storage and detention basin based on a balanced perspective, a medium, and a product.

### BACKGROUND

Under the dual impact of global climate change and human activities, the frequency, intensity, duration, and scope of extreme rainstorms have increased significantly, resulting in the further increase of an occurrence probability of extraordinary floods. In order to prevent major floods, a basin flood control engineering system that is based on embankments, adopts reservoirs as a backbone, coordinates flood storage and detention basins with river regulation, and combines Pingyuan Xinghong with water and soil conservation has been produced in China through more than 70 years of construction. Reservoirs, embankments, and flood storage and detention basins undertake the tasks of flood retention, flood flowing, and flood diversion, respectively, and a positional relationship of reservoirs, embankments, and flood storage and detention basins is shown in FIG. 2. Flood water is first impounded through upstream reservoirs, and the excess flood water is safely discharged into seas through embankments. When a magnitude of a flood is too high and exceeds a safe discharge capacity of an embankment, the excess flood water undergoes diversion and storage through a flood storage and detention basin. Therefore, flood storage and detention basins are an important constituent part of the basin flood control engineering system, and are the last resort (“bottomline”) to ensure the safety of basin flood control. With the rapid development of social economy, the inundation loss caused by the enabling of flood storage and detention basins is getting bigger and bigger, and it is increasingly difficult to make a decision on the enabling of flood storage and detention basins. From the perspective of protecting the overall situation and selecting the minimum among several evils, the enabling of flood storage and detention basins is essentially a measure to relieve a pressure on the flood control across rivers and sacrifice localities for protecting key points. There is currently no set of advanced and applicable methods to quickly determine a flood-diversion time of a flood storage and detention basin, formulate an inputting order, determine the number of enabling days, and calculate a scheduling effect during a catastrophic flood event. The common hydrodynamic model methods affect the valuable research and determination time for flood control due to disadvantages such as low calculation efficiency, large number of input parameters, and high terrain accuracy.

The development of various large and small things in the nature and society is a process of a balance-a conflict-formation of a new balance. When flood storage and detention basins are enabled, the problem of how to distribute an excess flood amount in different river sections is commonly encountered, namely, a balance of responsibility assignment and loss sharing between the excess flood and the operating water level of a river section where a flood control-protected zone is located and the time, quantity, order, and duration for enabling flood storage and detention basins. In order to allow the balance, a medium is adopted to provide a decision-making method where the benefits and losses of all parties are balanced through the comparison and selection of plans. Whether a flood diversion-enabling plan for flood storage and detention basins is reasonable or not is related to the balance of benefits and losses of all parties, and an unreasonable plan fails to balance the benefits and losses of all parties and sometimes even expands the original benefit-loss relationship to aggravate the unbalanced conflicts.

### SUMMARY

An objective of the present disclosure is to provide a method and device for determining a flood-diversion strategy of a flood storage and detention basin based on a balanced perspective, a medium, and a product, so as to support the timely and moderate scheduling and enabling of flood storage and detention basins, meet the rapid decision-making needs of key indicators for enabling flood storage and detention basins, and reduce the loss of a flood disaster.

To allow the above objective, the present disclosure provides the following solutions:

A method for determining a flood-diversion strategy of a flood storage and detention basin based on a balanced perspective is provided, including:
determining excess flood peaks and excess flood amounts of middle and downstream main streams in a preset time period after scheduling and enabling of a reservoir group in each river section;
constructing a correlation map between a flood-diversion amount and a flood-diversion water-level reduction value under each set flood-diversion parameter combination;
determining enabling priorities and flood-diversion volumes for all flood storage and detention basins in all river sections;
according to an order of the enabling priorities, determining a cumulative flood-diversion volume of each flood storage and detention basin, where a cumulative flood-diversion volume of any current flood storage and detention basin is a sum of flood-diversion volumes of all flood storage and detention basins with a higher enabling priority than the current flood storage and detention basin and a flood-diversion volume of the current flood storage and detention basin;
based on the correlation map and the cumulative flood-diversion volume of each flood storage and detention basin, constructing a flood storage and detention basin-enabling knowledge map;
based on the flood storage and detention basin-enabling knowledge map, determining a plurality of flood-diversion plans, where the plurality of flood-diversion plans each include a number of flood storage and detention basins enabled and a number of inputting days for each enabled flood storage and detention basin; and
based on an objective function and constraints, selecting a flood-diversion plan from the plurality of flood-diversion plans as a target plan to allow flood diversion, where the objective function is a minimum comprehensive disaster loss with respect to an enabled flood storage and detention basin, and the constraints are determined based on the excess flood amounts, the excess flood peaks, and water levels after flood diversion.

Optionally, the determining excess flood peaks and excess flood amounts of middle and downstream main streams in a preset time period after scheduling and enabling of a reservoir group in each river section includes:
determining any reservoir in a reservoir group of any current river section as a current reservoir, and determining any time point in the preset time period as a current time point;
determining an uncontrolled-zone inflow rate and an inflow control station-measured flow rate for the current reservoir at the current time point;
based on the uncontrolled-zone inflow rate and the inflow control station-measured flow rate at the current time point, determining an inflow flood amount of the current reservoir at the current time point;
based on the inflow flood amount of the current reservoir at the current time point, determining an outflow flood amount of the current reservoir at the current time point by a reservoir-group flood-regulation model;
based on outflow flood amounts of all reservoirs in the current river section at the current time point, determining a water-incoming boundary at the current time point;
based on the water-incoming boundary at the current time point, determining a pre-flood-diversion water level and a pre-flood-diversion flow rate of a main control station of the current river section at the current time point;
acquiring a safe discharge capacity of the current river section; and
based on the safe discharge capacity and a pre-flood-diversion flow rate of the main control station of the current river section at each time point in the preset time period, calculating an excess flood peak and an excess flood amount of the current river section in the preset time period.

Optionally, the constructing a correlation map between a flood-diversion amount and a flood-diversion water-level reduction value under each set flood-diversion parameter combination includes:
determining a plurality of set flood-diversion parameter combinations, where the plurality of set flood-diversion parameter combinations each include: a set flood-diversion flow rate, a number of set flood-diversion dates, and a set flood-diversion duration on each flood-diversion date;
determining the flood-diversion amount and the flood-diversion water-level reduction value under each set flood-diversion parameter combination, where the flood-diversion water-level reduction value is a water-level reduction value before and after flood diversion is conducted with the flood-diversion amount under each set flood-diversion parameter combination; and
based on all set flood-diversion parameter combinations and corresponding flood-diversion amounts and flood-diversion water-level reduction values, constructing the correlation map between the flood-diversion amount and the flood-diversion water-level reduction value under each set flood-diversion parameter combination.

Optionally, the determining the flood-diversion amount and the flood-diversion water-level reduction value under each set flood-diversion parameter combination includes:
based on a set flood-diversion flow rate, a number of set flood-diversion dates, and a set flood-diversion duration on each flood-diversion date in each set flood-diversion parameter combination, calculating the flood-diversion amount under each set flood-diversion parameter combination; and
based on the flood-diversion amount under each set flood-diversion parameter combination, determining the flood-diversion water-level reduction value under each set flood-diversion parameter combination.

Optionally, the constraints include:
a cumulative flood-diversion volume of a flood storage and detention basin enabled in a flood-diversion plan is greater than or equal to an excess flood amount in the preset time period;
a flood-diversion capacity of a gate of a flood storage and detention basin enabled in a flood-diversion plan is greater than or equal to an excess flood peak in the preset time period; and
a water level after flood diversion using a flood-diversion plan is lower than a guaranteed water level.

Optionally, after the flood-diversion plan is selected from the plurality of flood-diversion plans as the target plan based on the objective function and the constraints to allow the flood diversion, the method further comprises:
based on a water level after flood diversion using the target plan and a water level before the flood diversion using the target plan, calculating a flood-diversion water-level reduction value of the target plan.

A computer device is provided, including a memory, a processor, and a computer program stored in the memory and executable on the processor, where the processor executes the computer program to implement steps of the method for determining a flood-diversion strategy of a flood storage and detention basin based on a balanced perspective described above.

A computer-readable storage medium in which a computer program is stored is provided, where the computer program is executed by a processor to implement steps of the method for determining a flood-diversion strategy of a flood storage and detention basin based on a balanced perspective described above.

A computer program product is provided, including a computer program, where when executed by a processor, the computer program implements steps of the method for determining a flood-diversion strategy of a flood storage and detention basin based on a balanced perspective described above.

According to the specific embodiments provided by the present disclosure, the present disclosure discloses the following technical effects:

The present disclosure discloses a method and device for determining a flood-diversion strategy of a flood storage and detention basin based on a balanced perspective, a medium, and a product. Through a flood storage and detention basin-enabling knowledge map, different flood-diversion times and an enabling priority, a number of enabling days, and a scheduling effect for each flood storage and detention basin are integrated on one map to intuitively display a flood-diversion effect of a plan for enabling different flood storage and detention basins. Therefore, the present disclosure can balance a relationship between flood-diversion needs and flood-diversion capacities of flood storage and detention basins, support the timely and moderate scheduling and enabling of flood storage and detention basins and the rapid evaluation of a plan, adapt to complicated flood scenarios, improve a computing efficiency for different flood-diversion needs, shorten a decision-making time when a disaster comes, fully reflect an advanced nature of a plan for enabling flood storage and detention basins under different flood disaster conditions, maximize a flood-diversion effect of a flood storage and detention basin, and reduce a loss caused by improper selection of a flood storage and detention basin.

### BRIEF DESCRIPTION OF THE DRAWINGS

To describe the technical solutions in the embodiments of the present disclosure or in the prior art clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a schematic flow chart of the method for determining a flood-diversion strategy of a flood storage and detention basin based on a balanced perspective provided in Embodiment 1 of the present disclosure;

FIG. 2 is a schematic diagram of a distribution of a basin flood control engineering system;

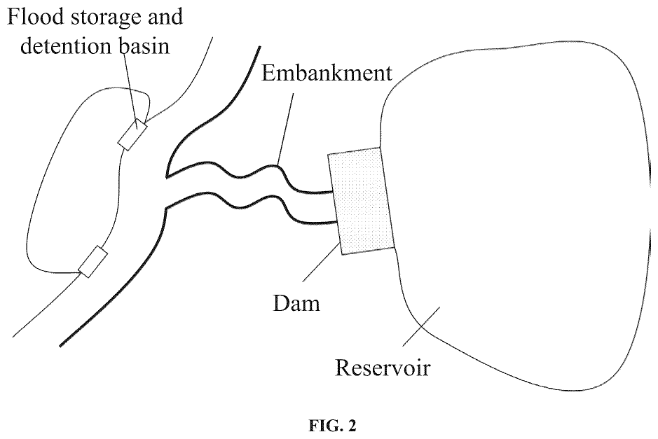

FIG. 3 is a schematic diagram of a method for coupled calculation of a flood-diversion time, an inputting order, a number of enabling days, and a scheduling effect for a flood storage and detention basin based on a balanced perspective;

FIG. 4 is a schematic diagram of a correlation map between a flood-diversion amount and a flood-diversion water-level reduction value under each set flood-diversion parameter combination for a Chenglingji river section;

FIG. 5 is a schematic diagram of a set of correlation curves between a threshold range of a flood-diversion effect and a feasible region of a flood storage capacity for each flood storage and detention basin; and

FIG. 6 is a diagram of an internal structure of a computer apparatus.

### DETAILED DESCRIPTION OF THE EMBODIMENTS

The technical solutions of the embodiments of the present disclosure are clearly and completely described below with reference to the accompanying drawings in the embodiments of the present disclosure. Apparently, the embodiments are merely some rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a method and device for determining a flood-diversion strategy of a flood storage and detention basin based on a balanced perspective, a medium, and a product, which is intended to support the timely and moderate scheduling and enabling of flood storage and detention basins, meet the rapid decision-making needs of key indicators for enabling flood storage and detention basins, and reduce the loss of a flood disaster.

In order to make the above objective, features, and advantages of the present disclosure clear and comprehensible, the present disclosure will be further described in detail below in combination with the accompanying drawings and specific implementations.

### Embodiment 1

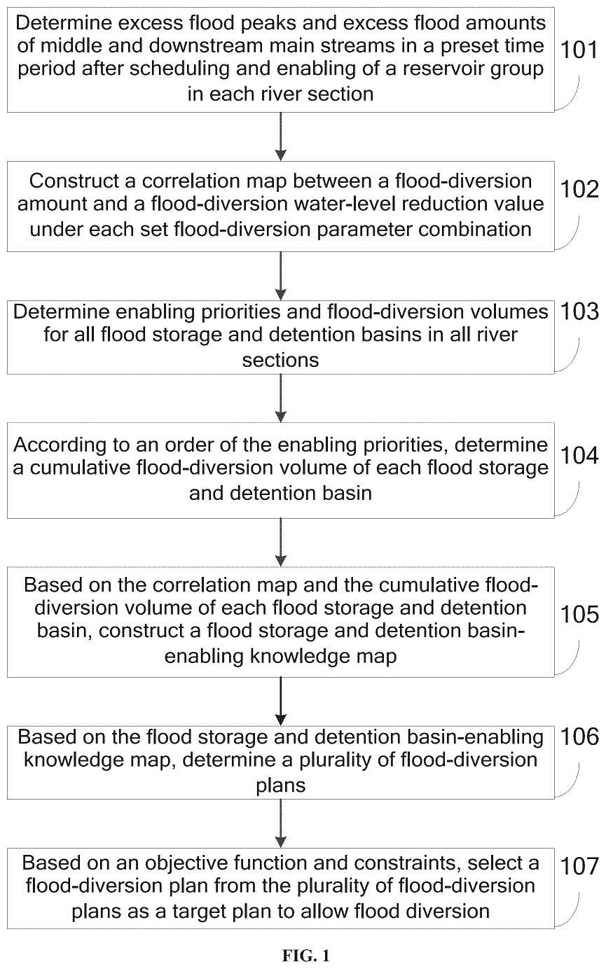

As shown in FIG. 1, a method for determining a flood-diversion strategy of a flood storage and detention basin based on a balanced perspective is provided in this embodiment, including:
Step 101: Excess flood peaks and excess flood amounts of middle and downstream main streams in a preset time period after scheduling and enabling of a reservoir group in each river section are determined.

As an optional implementation, the step 101 includes:
Step 1011: Any reservoir in a reservoir group of any current river section is determined as a current reservoir, and any time point in the preset time period is determined as a current time point.
Step 1012: An uncontrolled-zone inflow rate and an inflow control station-measured flow rate for the current reservoir at the current time point are determined.
Step 1013: Based on the uncontrolled-zone inflow rate and the inflow control station-measured flow rate at the current time point, an inflow flood amount of the current reservoir at the current time point is determined.
Step 1014: Based on the inflow flood amount of the current reservoir at the current time point, an outflow flood amount of the current reservoir at the current time point is determined by a reservoir-group flood-regulation model.
Step 1015: Based on outflow flood amounts of all reservoirs in the current river section at the current time point, a water-incoming boundary at the current time point is determined.
Step 1016: Based on the water-incoming boundary at the current time point, a pre-flood-diversion water level and a pre-flood-diversion flow rate of a main control station of the current river section at the current time point are determined.
Step 1017: A safe discharge capacity of the current river section is acquired.
Step 1018: Based on the safe discharge capacity and a pre-flood-diversion flow rate of the main control station of the current river section at each time point in the preset time period, an excess flood peak and an excess flood amount of the current river section in the preset time period are calculated.
Step 102: A correlation map between a flood-diversion amount and a flood-diversion water-level reduction value under each set flood-diversion parameter combination is constructed.

As an optional implementation, the step 102 includes:
Step 1021: A plurality of set flood-diversion parameter combinations are determined. The plurality of set flood-diversion parameter combinations each include: a set flood-diversion flow rate, a number of set flood-diversion dates, and a set flood-diversion duration on each flood-diversion date.
Step 1022: The flood-diversion amount and the flood-diversion water-level reduction value under each set flood-diversion parameter combination are determined. The flood-diversion water-level reduction value is a water-level reduction value before and after flood diversion is conducted with the flood-diversion amount under each set flood-diversion parameter combination.

As an optional implementation, the step 1022 includes:
Step 10221: Based on a set flood-diversion flow rate, a number of set flood-diversion dates, and a set flood-diversion duration on each flood-diversion date in each set flood-diversion parameter combination, the flood-diversion amount under each set flood-diversion parameter combination is calculated.
Step 10222: Based on the flood-diversion amount under each set flood-diversion parameter combination, the flood-diversion water-level reduction value under each set flood-diversion parameter combination is determined.
Step 1023: Based on all set flood-diversion parameter combinations and corresponding flood-diversion amounts and flood-diversion water-level reduction values, the correlation map between the flood-diversion amount and the flood-diversion water-level reduction value under each set flood-diversion parameter combination is constructed.
Step 103: Enabling priorities and flood-diversion volumes for all flood storage and detention basins in all river sections are determined.
Step 104: According to an order of the enabling priorities, a cumulative flood-diversion volume of each flood storage and detention basin is determined.

A cumulative flood-diversion volume of any current flood storage and detention basin is a sum of flood-diversion volumes of all flood storage and detention basins with a higher enabling priority than the current flood storage and detention basin and a flood-diversion volume of the current flood storage and detention basin.
Step 105: Based on the correlation map and the cumulative flood-diversion volume of each flood storage and detention basin, a flood storage and detention basin-enabling knowledge map is constructed.
Step 106: Based on the flood storage and detention basin-enabling knowledge map, a plurality of flood-diversion plans are determined.

The plurality of flood-diversion plans each include a number of flood storage and detention basins enabled and a number of inputting days for each enabled flood storage and detention basin.
Step 107: Based on an objective function and constraints, a flood-diversion plan is selected from the plurality of flood-diversion plans as a target plan to allow flood diversion.

The objective function is a minimum comprehensive disaster loss with respect to an enabled flood storage and detention basin. The constraints are determined based on the excess flood amounts, the excess flood peaks, and water levels after flood diversion.

As an optional implementation, the constraints include:

A cumulative flood-diversion volume of a flood storage and detention basin enabled in a flood-diversion plan is greater than or equal to an excess flood amount in the preset time period.

A flood-diversion capacity of a gate of a flood storage and detention basin enabled in a flood-diversion plan is greater than or equal to an excess flood peak in the preset time period; and
a water level after flood diversion using a flood-diversion plan is lower than a guaranteed water level.

As an optional implementation, after the step 107, the method further includes:

Based on a water level after flood diversion using the target plan and a water level before the flood diversion using the target plan, a flood-diversion water-level reduction value of the target plan is calculated.

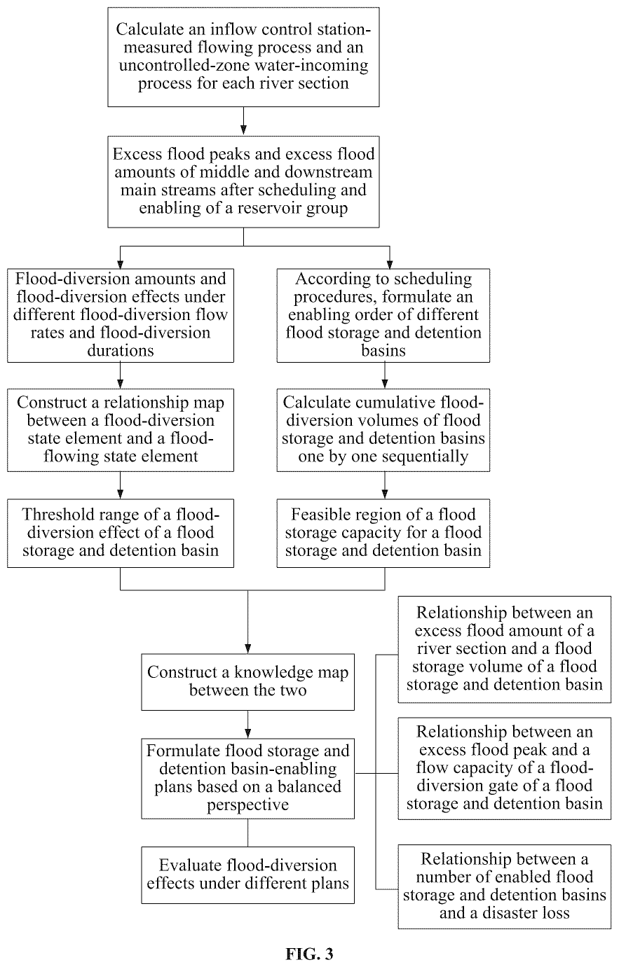

In order to implement the method in Embodiment 1, as shown in FIG. 3, a method for coupled calculation of a flood-diversion time, an inputting order, a number of enabling days, and a scheduling effect for a flood storage and detention basin based on a balanced perspective is also provided, including:
S1: Excess flood peaks and excess flood amounts of middle and downstream main streams after scheduling and enabling of a reservoir group are calculated for each river section to determine flood-diversion needs.

### (1) Calculation of Reservoir Flood-Regulation and a River Flood

1). An uncontrolled-zone inflow rate Qᵢₙ₂ᵢ(t) of an ith reservoir at a time point t(tϵ[T1, T2]) is calculated through a lumped hydrological model such as a Xin'an River model, a tank model, a national hydrologic model (NHM), an antecedent precipitation index (API) model, or a unit hydrograph model or an improved distributed hydrological model. An uncontrolled zone of a reservoir refers to a part without flow rate monitoring by a hydrologic station. T1 refers to an initial time point in the preset time period [T1, T2], and T2 refers to an end time point of the preset time period [T1, T2].
2). With an inflow control station-measured flow rate Qᵢₙ₁ᵢ(t) and the uncontrolled-zone inflow rate Qᵢₙ₂ᵢ(t) of the ith reservoir at the time point t as inputs, an inflow flood amount Qᵢₙᵢ(t) of the ith reservoir at the time point t is calculated by a Muskingum segmentation algorithm.
3). With Qᵢₙᵢ(t) as an input, an outflow flood amount Qₒᵤₜᵢ(t) of the ith reservoir at the time point t after flood retention, peak clipping, and peak shifting is calculated based on a reservoir-group flood-regulation model.
4). With Qₒᵤₜᵢ(t) as an input, a flow process from the ith reservoir to control cross sections of main and branch streams of a river section at the time point t is calculated by a Muskingum segmentation algorithm to obtain a water-incoming boundary Qₒ(t) at the time point t resulting from main stream calculation for middle and downstream plain river sections.
5). Based on Qₒ(t), incoming water of middle and downstream main streams is calculated by a hydrodynamic model to obtain a pre-flood-diversion water level Z(t) and a pre-flood-diversion flow rate Q(t) of the main control station at the time point t.

### (2) Calculation of Excess Flood Peaks and Excess Flood Amounts

1). A guaranteed water level Z_{g} and a safe discharge capacity Qₛ of a main-stream control station are consulted. If there is no safe discharge capacity Qₛ, the safe discharge capacity can be calculated based on Z_{g} by a water level-flow rate relationship curve or a hydrodynamic model.
2. According to Q(t) and the safe discharge capacity Qₛ, an excess flood peak Q_{c}(t1) and an excess flood amount Wc are calculated according to the following calculation formulas:

$${Q}_{c} ( t 1 ) = MAX ( Q ( t ) ) - {Q}_{s} , t ∈ [ T 1 , T 2 ] \qquad ( 1 )$$

$$Wc = SUM ( {Q}_{j} ( t 2 ) - {Q}_{s} ) , \qquad ( 2 )$$

where Qⱼ(t2) represents a pre-flood-diversion flow rate at each time point when a pre-flood-diversion flow rate exceeds the safe discharge capacity in a preset time period [T1, T2]; MAX( ) represents a maximum function; SUM( ) represents a summation function; SUM(Qⱼ(t2)−Qₛ) represents a total amount of excess water when a pre-flood-diversion flow rate exceeds the safe discharge capacity; MAX(Q(t)) represents a maximum flow rate in the preset time period [T1, T2], namely, a peak flood flow rate; and Q_{c}(t1) represents an excess flood peak corresponding to a maximum flow rate at a time point t1 in the preset time period [T1, T2].
S2: Flood-diversion amounts and flood-diversion effects (namely, flood-diversion water-level reduction values) under different assumed flood-diversion flow rates and flood-diversion durations (namely, set flood-diversion parameter combinations) are analyzed, a relationship map between a flood-diversion state element and a flood-flowing state element (namely, a correlation map between a flood-diversion amount and a flood-diversion water-level reduction value) is constructed, and a threshold range of a flood-diversion effect is determined.

### (1) Calculation of Flood-Diversion Amounts Under Different Assumed Flood-Diversion Flow Rates and Flood-Diversion Durations

A calculation formula for the flood-diversion amounts Wₙ under different assumed flood-diversion flow rates and flood-diversion durations is as follows:

$${W}_{n} = {\sum }_{1}^{n} {Q}_{1} {t}_{n} , n = 1 , 2 , 3 … n , \qquad ( 3 )$$

where Q₁ represents an assumed flood-diversion flow rate; n represents an assumed number of flood-diversion days (namely, a set number of flood-diversion dates); and tₙ represents an assumed flood-diversion duration on the nth day. It can be seen that the higher the flood-diversion flow rate, the larger the flood-diversion amount Wₙ, and the longer the flood-diversion duration, the larger the flood-diversion amount.

### (2) Calculation of Flood-Diversion Effects Under Different Assumed Flood-Diversion Flow Rates and Flood-Diversion Durations

According to the flood-diversion amounts under different assumed flood-diversion flow rates and flood-diversion durations, a reduced water-level value of a flood control station of each river section is obtained with reference to a hydrodynamic model or a water level-flow rate relationship curve (namely, a flood-diversion water-level reduction value under a corresponding set flood-diversion parameter combination). A calculation formula for the flood-diversion water-level reduction value under any assumed flood-diversion flow rate and flood-diversion duration is as follows:

$$Δ {Z}_{y} = {Z}_{by} - {Z}_{ay} , \qquad ( 4 )$$

where Z_{by} represents a water level of the yth flood control station before flood-diversion, and is determined based on an excess flood amount before flood diversion; Z_{ay} represents a water level of the yth flood control station after flood diversion, and is determined based on an excess flood amount after flood diversion; and ΔZ_{y} represents a water-level reduction value of the yth flood control station.

### (3) Construction of a Relationship Map Between a Flood-Diversion State Element and a Flood-Flowing State Element

A correlation map between a flood-diversion state element (which is characterized by a flood-diversion flow rate, a flood-diversion duration (including an assumed number of flood-diversion days and an assumed flood-diversion duration on each flood-diversion date), and a flood-diversion amount) and a flood-flowing state element (which is characterized by a reduced water level value) is constructed by an Excel table to obtain corresponding flood-diversion amounts and water level changes under different flood-diversion flow rates and flood-diversion durations. Under a same flood-diversion duration or a same number of days for enabling a flood storage and detention basin, the larger the flood-diversion flow rate, the higher the flood-diversion speed, the larger the cumulative flood-diversion amount, and the larger the water-level reduction value of a flood control station in a river section. Under a same flood-diversion flow rate, the longer the flood-diversion duration, the larger the cumulative flood-diversion amount, and the larger the water-level reduction value of the flood control station.
S3: According to scheduling procedures for flood storage and detention basins, an enabling order of flood storage and detention basins in different river sections is formulated, and cumulative flood-diversion volumes of the flood storage and detention basins are calculated one by one sequentially to determine a feasible region for a flood storage capacity of each flood storage and detention basin (namely, a cumulative flood-diversion volume).

### (1) Determination of an Enabling Order of Flood Storage and Detention Basins in Different River Sections

1). Flood storage and detention basins are classified according to river sections: a flood storage and detention basin group in a river section A, a flood storage and detention basin group in a river section B, and a flood storage and detention basin group in a river section C. The flood storage and detention basin groups are enabled sequentially from upstream to downstream according to the river sections.
2). According to the probability of enabling a flood storage and detention basin and the importance of a protected object, flood storage and detention basins are divided into the following three categories: important flood storage and detention basins, general flood storage and detention basins, and reserved flood storage and detention basins. There is a high probability of enabling the important flood storage and detention basins, and the important flood storage and detention basins are generally enabled once every 20 or fewer years. The general flood storage and detention basins are provided to protect against floods meeting or lower than the flood control standard. The reserved flood storage and detention basins are provided to protect against exceeding-design floods or catastrophic floods. The “important”, “general”, and “reserved” flood storage and detention basins shall be determined in accordance with the scheduling procedures for flood storage and detention basins and the national construction planning for flood storage and detention basins.
3). The important flood storage and detention basins are preferentially enabled, and then the general flood storage and detention basins are enabled. If an excess water level still cannot be reduced to be lower than the guaranteed water level, the reserved flood storage and detention basins will be enabled finally.
4). A final order for enabling flood storage and detention basins is as follows: The important flood storage and detention basins in a flood storage and detention basin group of an upstream river section are first enabled, then the general flood storage and detention basins in the flood storage and detention basin group of the upstream river section are enabled, and finally the reserved flood storage and detention basins in the flood storage and detention basin group of the upstream river section are enabled. According to positions of river sections, flood storage and detention basin groups of downstream river sections are enabled sequentially. An enabling order k of flood storage and detention basins is as follows: starting from No. 1, numbering is conducted with natural numbers from small to large until No. q.

### (2) Calculation of a Cumulative Flood-Diversion Volume of Each Flood Storage and Detention Basin

1). A water level-area-volume relationship for each flood storage and detention basin is calculated according to topographic data, a flood-diversion volume Vₐ(k) of the kth flood storage and detention basin is determined. Flood-diversion volumes of flood storage and detention basins are ranked according to an enabling order of the flood storage and detention basins.
2). According to an enabling order of flood storage and detention basins, the accumulation is conducted sequentially from No. 1 to No. q to finally obtain a cumulative flood-diversion volume V_{A}(k) corresponding to the enabling of the kth flood storage and detention basin, and recursive formulas are as follows:

$${V}_{A} ( k ) = {V}_{A} ( k - 1 ) + {V}_{a} ( k ) , k > 1 \qquad ( 5 )$$

$$and$$

$${V}_{A} ( 1 ) = {V}_{a} ( 1 ) , k = 1 , \qquad ( 6 )$$

where V_{A}(k) represents a cumulative flood-diversion volume from the first flood storage and detention basin to the kth flood storage and detention basin, that is, the cumulative flood-diversion volume corresponding to the enabling of the kth flood storage and detention basin; V_{A}(1) represents a cumulative flood-diversion volume corresponding to the enabling of the first flood storage and detention basin; and Vₐ(1) represents a flood-diversion volume of the first flood storage and detention basin.
3). Finally, a maximum cumulative flood-diversion volume V_{A}(q) is obtained, namely, a maximum volume allowing for flood diversion when all flood storage and detention basins are enabled. A maximum and a feasible region for a flood storage capacity of a flood storage and detention basin are determined.
S4: A knowledge map between a threshold range of a flood-diversion effect (namely, a water-level reduction value before and after flood diversion is conducted with a flood-diversion amount under each set flood-diversion parameter combination) and a feasible region of a flood storage capacity for each flood storage and detention basin (namely, a flood storage and detention basin-enabling knowledge map) is constructed, flood storage and detention basin-enabling plans are formulated based on a balanced perspective, and flood-diversion effects under different plans are evaluated.

### (1) Construction of a Knowledge Map Between a Threshold Range of a Flood-Diversion Effect and a Feasible Region of a Flood Storage Capacity for Each Flood Storage and Detention Basin

A set of correlation curves between a threshold range of a flood-diversion effect and a feasible region of a flood storage capacity for each flood storage and detention basin is constructed by an Excel table to obtain a flood storage and detention basin-enabling knowledge map.

### (2) Formulation of Flood Storage and Detention Basin-Enabling Plans Based on a Balanced Perspective

1). A number of enabled flood storage and detention basins is determined based on a relative size of an excess flood amount of a river section relative to a flood storage volume of a flood storage and detention basin.

When an excess flood amount Wc of a river section reaches a specified value, the method can provide a plurality of plans for enabling flood storage and detention basins. Flood storage volumes Vₐₘ of different flood storage and detention basins are combined to obtain a cumulative flood-diversion volume V_{A}. A number of flood storage and detention basins that need to be enabled is determined according to a size relationship between an excess flood amount Wc and a cumulative flood-diversion volume, and a formula is as follows:

$${V}_{A} ( m ) = {\sum }_{k = 1}^{m} {V}_{a} ( k ) ( m = 1 , 2 , 3 , … , q ) . \qquad ( 7 )$$

The following constraint needs to be met:

$${V}_{A} ( m ) \geq Wc , \qquad ( 8 )$$

where m represents a number of enabled flood storage and detention basins.

When an excess flood amount of a river section exceeds a flood storage volume of the original flood storage and detention basins, a number of enabled flood storage and detention basins should be increased such that a flood storage volume of flood storage and detention basins is greater than the excess flood amount of the river section. However, a number of enabled flood storage and detention basins should be as small as possible.
2). A number of enabled flood storage and detention basins is determined based on a relative size of an excess flood peak relative to a flood-diversion capacity of a flood storage and detention basin.

When an excess flood peak Q_{c} is greater than a flood-diversion capacity Q_{cap} of gates of a plurality of input flood storage and detention basins, a flood-diversion flow rate is increased usually by increasing a number of enabled flood storage and detention basins or blasting a flood-diversion port entrance of an embankment in a flood storage and detention basin, such that the excess flood peak can be discharged into flood storage and detention basins as soon as possible. Therefore, when a flood storage and detention basin is selected, designed flow capacities Q_{cap} of a flood-diversion gate and a flood-diversion port entrance of the flood storage and detention basin should be consulted, and when this factor is considered, the following constraint needs be met:

$${Q}_{cap} \geq {Q}_{c} ( t 1 ) . \qquad ( 9 )$$

While buildings of hydraulic engineering are not destroyed, a plan where an excess flood peak is greater than a designed flow capacity of a flood storage and detention basin is eliminated from the existing plans.
3). A number of enabled flood storage and detention basins is comprehensively determined based on a balanced perspective.

When a plan is adopted according to an enabling order k of flood storage and detention basins, the increase in a number of input flood storage and detention basins can make an assumed flood-diversion flow rate Q₁ of each plan increase, make ΔZ_{y} increase, and make Z_{ay} drop to be lower than a guaranteed water level such that a flood-diversion effect can be optimized locally, and a disaster loss f_{b} at this time point can be calculated accordingly. With the increase in a number of enabled flood storage and detention basins, a flood-diversion loss increases, and an additional disaster loss fₐᵣ(n) at this time point can be calculated accordingly.

With an excess flood amount of a river section being less than a flood storage volume of a flood storage and detention basin and an excess flood peak being less than a designed flow capacity as constraints and with a minimum comprehensive disaster loss F(r) of an enabled flood storage and detention basin as an objective function, benefits and losses of all parties are balanced by an optimization algorithm to finally determine a number of flood storage and detention basins that need to be enabled, and a calculation formula is as follows:

$$F ( r ) = MIN ( {f}_{ar} ( n ) + {f}_{b} ) , \qquad ( 10 )$$

where r represents the rth plan implemented; MIN( ) represents a minimum function; MIN(fₐᵣ(n)+f_{b}(n)) represents a minimum disaster loss when the rth plan is implemented; n represents a number of flood storage and detention basins enabled in the rth plan; fₐᵣ(n) represents an additional disaster loss after the rth plan is implemented; and f_{b} represents an existing disaster loss before the rth plan is implemented.

### (3) Evaluation of Flood-Diversion Effects Under Different Plans

1). Based on the above steps, a water-level reduction value ΔZᵢ of a flood control station of each river section can be calculated. A desired final flood-diversion effect is that a water level Z_{ay}(r) of each flood control station after flood diversion is conducted with the rth plan is lower than a guaranteed water level Z_{g}, as shown in the following formula:

$${Z}_{ay} ( r ) \geq {Z}_{g} , \qquad ( 11 )$$

where Z_{ay}(r) represents a water level of the yth flood control station after flood diversion is conducted with the rth plan.
2). In the present disclosure, scheduling effects under different plans are evaluated according to a water level difference of a main-stream river section before and after flood diversion of flood storage and detention basins. The more the water level reduction, the better the flood-diversion effect.
3). According to different combined plans of a flood-diversion time, an inputting order, and a number of enabling days for flood storage and detention basins, a scheduling effect after enabling of flood storage and detention basins is evaluated. That is, under the premise of allowing a flood-diversion target, the larger the water level difference ΔZ_{y} of a main-stream control station, the better the flood-diversion effect.

In summary, final constraints include formula (8), formula (9), and formula (11).

The present disclosure is described in detail with a flood-diversion plan for middle and downstream flood storage and detention basins of the Yangtze River in the present disclosure as an embodiment. The present disclosure can also play a guiding role when used in the formulation of other flood storage and detention basin-enabling plans.

(1) Excess flood peaks and excess flood amounts of middle and downstream river sections after scheduling and enabling of a reservoir group each are calculated to determine flood-diversion needs.

In the 300-year flood in 1935, according to the existing scheduling procedures, statistical results of interception and storage capacities of the Three Gorges and upstream reservoir groups are shown in Table 1 below.

TABLE 1
Interception and storage capacities of upstream reservoir
groups under the current working conditions

| | Interception and storage | Total | Maximum |
|---|---|---|---|
| Interception and storage | capacity of a reservoir | interception | flood-regulation |
| capacity of the Three | group upstream of | and storage | water level of |
| Gorges reservoir | the Three Gorges | capacity | the Three |
| (100,000,000 m³) | (100,000,000 m³) | (100,000,000 m³) | Gorges (m) |
| 151.4 | 76.5 | 227.9 | 167.59 |

In order to analyze the excess flood amounts in the middle and lower reaches, the calculation is conducted with flood-diversion water-level control solutions for a Shashi station (45.0 m), a Chenglingji station (34.4 m), a Hankou station (29.5 m), and a Hukou station (22.5 m). Calculation results of the excess flood amounts for the 300-year flood in 1935 are shown in Table 2.

TABLE 2
Excess flood amounts in the middle and lower reaches of
the Yangtze River under the current working conditions

| | | Excess flood amounts (100,000,000 m³) | | | | |
|---|---|---|---|---|---|---|
| | | Jingjiang | Region | Region | Region | Total |
| Flood design | | river | around | around | around | flood-diversion |
| Flood frequency | Year | section | Chenglingji | Wuhan | Hukou | amount |
| Once in 500 years | 1935 | 0 | 251 | 43 | 0 | 294 |
| Effective volume | Important + | 54 | 238 | 108 | 50 | 450 |
| of a flood | general | | | | | |
| storage and | Reserved | 18 | 100 | 22 | 0 | 140 |
| detention | Total | 72 | 338 | 130 | 50 | 590 |
| basin | | | | | | |
| (100,000,000 m³) | | | | | | |

It can be seen from Table 2 that the excess flood amounts are mainly concentrated in river sections around Chenglingji.

(2) Flood-diversion amounts and flood-diversion effects under different assumed flood-diversion flow rates and flood-diversion durations are analyzed, a relationship map between a flood-diversion state element and a flood-flowing state element is constructed, and a threshold range of a flood-diversion effect is determined.

With a flood control station Lianhuatang of the Chenglingji river section as a representative station, a flood-diversion amount and a flood-diversion effect (which is characterized by a water-level reduction value of the Lianhuatang station for the main stream of the Yangtze River) under each plan are calculated according to different assumed flood-diversion flow rates and flood-diversion durations. As shown in Table 3 and Table 4, a unit of a flood-diversion amount is 100,000,000 m³ and a unit of a flood-diversion effect is m.

TABLE 3
Flood-diversion amounts and flood-diversion effects under a first set
of assumed flood-diversion flow rates and flood-diversion durations

| Flood-diversion | | Flood-diversion time | | | | | |
|---|---|---|---|---|---|---|---|
| flow rate (m³/s) | Item | Day 1 | Day 2 | Day 3 | Day 4 | Day 5 | Day 6 |
| 2000 | Flood-diversion | 1.73 | 3.46 | 5.18 | 6.91 | 8.64 | 10.37 |
| | amount | | | | | | |
| | Flood-diversion | 0.04 | 0.08 | 0.1 | 0.12 | 0.14 | 0.15 |
| | effect | | | | | | |
| 4000 | Flood-diversion | 3.46 | 6.91 | 10.37 | 13.82 | 17.28 | 20.74 |
| | amount | | | | | | |
| | Flood-diversion | 0.09 | 0.16 | 0.2 | 0.24 | 0.28 | 0.3 |
| | effect | | | | | | |
| 6000 | Flood-diversion | 5.18 | 10.37 | 15.55 | 20.74 | 25.92 | 31.1 |
| | amount | | | | | | |
| | Flood-diversion | 0.15 | 0.25 | 0.31 | 0.37 | 0.42 | 0.44 |
| | effect | | | | | | |
| 8000 | Flood-diversion | 6.91 | 13.82 | 20.74 | 27.65 | 34.56 | 41.47 |
| | amount | | | | | | |
| | Flood-diversion | 0.2 | 0.33 | 0.42 | 0.48 | 0.55 | 0.59 |
| | effect | | | | | | |
| 10000 | Flood-diversion | 8.64 | 17.28 | 25.92 | 34.56 | 43.2 | 51.84 |
| | amount | | | | | | |
| | Flood-diversion | 0.24 | 0.41 | 0.53 | 0.61 | 0.7 | 0.75 |
| | effect | | | | | | |
| 12000 | Flood-diversion | 10.37 | 20.74 | 31.1 | 41.47 | 51.84 | 62.21 |
| | amount | | | | | | |
| | Flood-diversion | 0.3 | 0.49 | 0.63 | 0.73 | 0.84 | 0.9 |
| | effect | | | | | | |
| 14000 | Flood-diversion | 12.1 | 24.19 | 36.29 | 48.38 | 60.48 | 72.58 |
| | amount | | | | | | |
| | Flood-diversion | 0.35 | 0.58 | 0.74 | 0.86 | 0.98 | 1.06 |
| | effect | | | | | | |
| 16000 | Flood-diversion | 13.82 | 27.65 | 41.47 | 55.3 | 69.12 | 82.94 |
| | amount | | | | | | |
| | Flood-diversion | 0.4 | 0.66 | 0.86 | 0.98 | 1.11 | 1.21 |
| | effect | | | | | | |
| 20000 | Flood-diversion | 17.28 | 34.56 | 51.84 | 69.12 | 86.4 | 103.68 |
| | amount | | | | | | |
| | Flood-diversion | 0.51 | 0.84 | 1.07 | 1.26 | 1.42 | 1.53 |
| | effect | | | | | | |

TABLE 4
Flood-diversion amounts and flood-diversion effects under a second set
of assumed flood-diversion flow rates and flood-diversion durations

| Flood-diversion | | Flood-diversion time | | | | | |
|---|---|---|---|---|---|---|---|
| flow rate (m³/s) | Item | Day 7 | Day 8 | Day 9 | Day 10 | Day 11 | Day 12 |
| 2000 | Flood-diversion | 12.1 | 13.82 | 15.55 | 17.28 | 19.01 | 20.74 |
| | amount | | | | | | |
| | Flood-diversion | 0.16 | 0.17 | 0.17 | 0.19 | 0.19 | 0.2 |
| | effect | | | | | | |
| 4000 | Flood-diversion | 24.19 | 27.65 | 31.1 | 34.56 | 38.02 | 41.47 |
| | amount | | | | | | |
| | Flood-diversion | 0.31 | 0.34 | 0.35 | 0.37 | 0.38 | 0.4 |
| | effect | | | | | | |
| 6000 | Flood-diversion | 36.29 | 41.47 | 46.66 | 51.84 | 57.02 | 62.21 |
| | amount | | | | | | |
| | Flood-diversion | 0.47 | 0.51 | 0.53 | 0.56 | 0.57 | 0.59 |
| | effect | | | | | | |
| 8000 | Flood-diversion | 48.38 | 55.3 | 62.21 | 69.12 | 76.03 | 82.94 |
| | amount | | | | | | |
| | Flood-diversion | 0.63 | 0.68 | 0.71 | 0.75 | 0.77 | 0.8 |
| | effect | | | | | | |
| 10000 | Flood-diversion | 60.48 | 69.12 | 77.76 | 86.4 | 95.04 | 103.68 |
| | amount | | | | | | |
| | Flood-diversion | 0.8 | 0.85 | 0.88 | 0.94 | 0.97 | 1 |
| | effect | | | | | | |
| 12000 | Flood-diversion | 72.58 | 82.94 | 93.31 | 103.68 | 114.05 | 124.42 |
| | amount | | | | | | |
| | Flood-diversion | 0.95 | 1.03 | 1.07 | 1.13 | 1.17 | 1.19 |
| | effect | | | | | | |
| 14000 | Flood-diversion | 84.67 | 96.77 | 108.86 | 120.96 | 133.06 | 145.15 |
| | amount | | | | | | |
| | Flood-diversion | 1.13 | 1.2 | 1.26 | 1.32 | 1.37 | 1.4 |
| | effect | | | | | | |
| 16000 | Flood-diversion | 96.77 | 110.59 | 124.42 | 138.24 | 152.06 | 165.89 |
| | amount | | | | | | |
| | Flood-diversion | 1.3 | 1.38 | 1.44 | 1.52 | 1.57 | 1.61 |
| | effect | | | | | | |
| 20000 | Flood-diversion | 120.96 | 138.24 | 155.52 | 172.8 | 190.08 | 207.36 |
| | amount | | | | | | |
| | Flood-diversion | 1.63 | 1.73 | 1.81 | 1.92 | 1.97 | 2.01 |
| | effect | | | | | | |

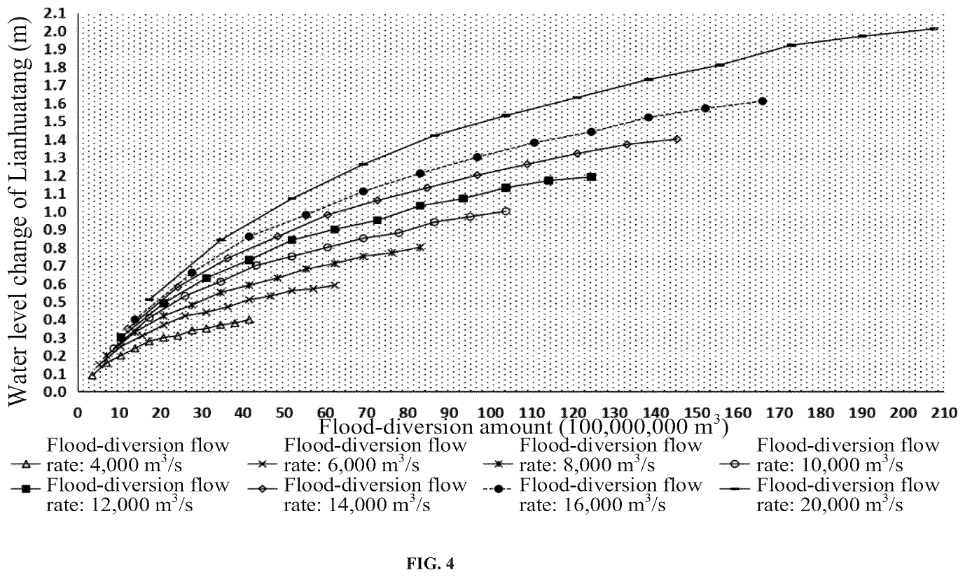

A correlation map between a flood-diversion state element and a flood-flowing state element (which is characterized by a water-level reduction value of the Lianhuatang station) for the Chenglingji river section is constructed, as shown in FIG. 4.

(3) According to scheduling procedures for flood storage and detention basins, an enabling order of flood storage and detention basins in different river sections is formulated, and cumulative flood-diversion volumes of the flood storage and detention basins are calculated one by one sequentially to determine a feasible region for a flood storage capacity of each flood storage and detention basin.

According to a probability of enabling a flood storage and detention basin and the importance of a protected object, an enabling order and cumulative flood-diversion volumes of flood storage and detention basins in the Chenglingji river section are determined and shown in Table 5.

TABLE 5
Feasible regions of flood storage capacities for flood storage and detention basins

| | Recommended order | | Volume of a flood | Cumulative |
|---|---|---|---|---|
| | for enabling flood | Nature of a flood | storage and | flood-diversion |
| | storage and | storage and | detention basin | volume |
| No | detention basins | detention basin | (100,000,000 m³) | (100,000,000 m³) |
| 1 | Qianlianghu Embankment | Important | 23.78 | 23.78 |
| 2 | Gongshuangcha | Important | 15.04 | 38.82 |
| | Embankment | | | |
| 3 | Datonghu East | Important | 11.67 | 50.49 |
| | Embankment | | | |
| 4 | Chengxi Embankment | Important | 7.92 | 58.41 |
| 5 | Minzhu Embankment | Important | 11.96 | 70.37 |
| 6 | Weidihu Embankment | Important | 2.22 | 72.59 |
| 7 | Xiguan Embankment | Important | 4.76 | 77.35 |
| 8 | Linan Embankment | Important | 2.21 | 79.56 |
| 9 | Honghu East Block | Important | 59.7 | 139.26 |
| 10 | Honghu Middle Block | General | 67.23 | 206.49 |
| 11 | Honghu West Block | Reserved | 49.75 | 256.24 |
| 12 | Jianshe Embankment | Important | 3.54 | 259.78 |
| 13 | Jianxin Embankment | General | 1.56 | 261.34 |
| 14 | Jiangnan Lucheng | General | 10.48 | 271.82 |
| | Embankment | | | |
| 15 | Quyuan Embankment | General | 12.45 | 284.27 |
| 16 | Jiuyuan Embankment | General | 3.82 | 288.09 |
| 17 | Liujiaoshan Embankment | Reserved | 0.61 | 288.7 |
| 18 | Anli Embankment | Reserved | 9.42 | 298.12 |
| 19 | Anchang Embankment | Reserved | 7.23 | 305.35 |
| 20 | Anhua Embankment | Reserved | 4.72 | 310.07 |
| 21 | Nanding Embankment | Reserved | 2.2 | 312.27 |
| 22 | Hekang Embankment | Reserved | 6.16 | 318.43 |
| 23 | Nanhan Embankment | Reserved | 6.15 | 324.58 |
| 24 | Yihe Embankment | Reserved | 0.79 | 325.37 |
| 25 | Beihu Embankment | Reserved | 1.91 | 327.28 |
| 26 | Jicheng Anhe | Reserved | 6.26 | 333.54 |
| | Embankment | | | |
| 27 | Junshan Embankment | Reserved | 4.69 | 338.23 |

(4) A knowledge map between a threshold range of a flood-diversion effect and a feasible region of a flood storage capacity for each flood storage and detention basin is constructed, flood storage and detention basin-enabling plans are formulated based on a balanced perspective, and flood-diversion effects under different plans are evaluated.

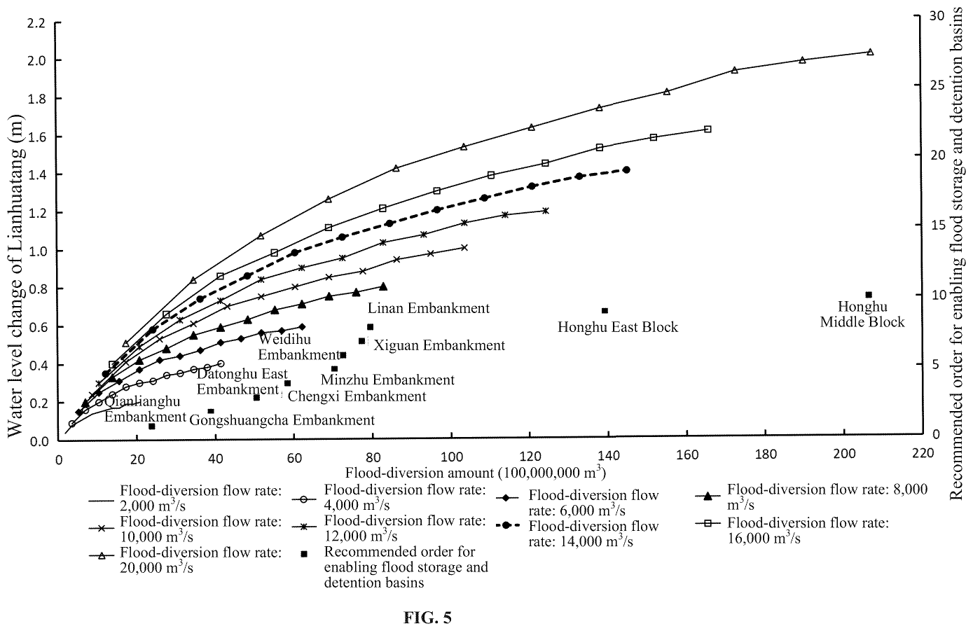

A set of correlation curves between a threshold range of a flood-diversion effect and a feasible region of a flood storage capacity for each flood storage and detention basin is constructed as a flood storage and detention basin-enabling knowledge map shown in FIG. 5. It can be seen from FIG. 5 that, with the increase of an excess flood amount, a number of flood storage and detention basins that need to be enabled continues to increase. When the excess flood amount is 2,000,000,000 m³, only the Qianlianghu Embankment needs to be enabled. When the excess flood amount increases to 20,000,000,000 m³, flood storage and detention basins that need to be enabled successively include Qianlianghu Embankment (an important flood storage and detention basin), Gongshuangcha Embankment (an important flood storage and detention basin), Datonghu East Embankment (an important flood storage and detention basin), Chengxi Embankment (an important flood storage and detention basin), Minzhu Embankment (an important flood storage and detention basin), Weidihu Embankment (an important flood storage and detention basin), Xiguan Embankment (an important flood storage and detention basin), Linan Embankment (an important flood storage and detention basin), Honghu East Block (an important flood storage and detention basin), and Honghu Middle Block (general flood storage and detention basin). In addition, with the increase of a flood-diversion flow rate (namely, a flow capacity of a flood-diversion port entrance), a flood storage and detention basin can be quickly filled. For example, when Qianlianghu Embankment and Gongshuangcha Embankment are adopted for flood diversion at an excess flood amount of 4,000,000,000 m³: If a flood-diversion flow rate is 4,000 m^{3/}s, a number of enabling days for the flood diversion reaches 11. If a flood-diversion flow rate increases to 6,000 m³/s, 8,000 m³/s, 10,000 m³/s, 12,000 m³/s, 16,000 m³/s, and 20,000 m³/s, successively, the number of enabling days for the flood diversion is reduced to 8, 6, 5, 4, 3, and 2, respectively. Therefore, with reference to this map, a flood-diversion time, an inputting order, and a number of enabling days for a flood storage and detention basin are determined according to a flood prediction period, a flood-control decision-making time, a volume of the flood storage and detention basin, and a size of a port entrance, and a scheduling effect after the flood storage and detention basin is enabled is evaluated, namely a water-level reduction value of a main-stream control station under the premise of allowing a flood-diversion target. For example, when an excess flood amount is less than 2,000,000,000 m³, only the Qianlianghu Embankment needs to be enabled. When flood diversion is conducted at 1,000 m³/s, a water level of the Lianhuatang is reduced by 0.02 m and 0.1 m on day 1 and day 12 of the flood diversion, respectively. When flood diversion is conducted at 10,000 m³/s, the water level of the Lianhuatang is reduced by 0.24 m and 1 m on day 1 and day 12 of the flood diversion, respectively. A decision-maker can determine an open-close mode of a gate accordingly. If a flow capacity of the gate is insufficient, it is determined whether blasting flood-diversion is adopted to increase a flood-diversion flow rate.

### Embodiment 2

A computer device is provided, including a memory, a processor, and a computer program stored in the memory and executable on the processor. The processor executes the computer program to implement steps of the method for determining a flood-diversion strategy of a flood storage and detention basin based on a balanced perspective in Example 1.

### Embodiment 3

A computer-readable storage medium in which a computer program is stored is provided. The computer program is executed by a processor to implement steps of the method for determining a flood-diversion strategy of a flood storage and detention basin based on a balanced perspective in Example 1.

### Embodiment 4

A computer program product is provided, including a computer program. When executed by a processor, the computer program implements steps of the method for determining a flood-diversion strategy of a flood storage and detention basin based on a balanced perspective in Example 1.

### Embodiment 5

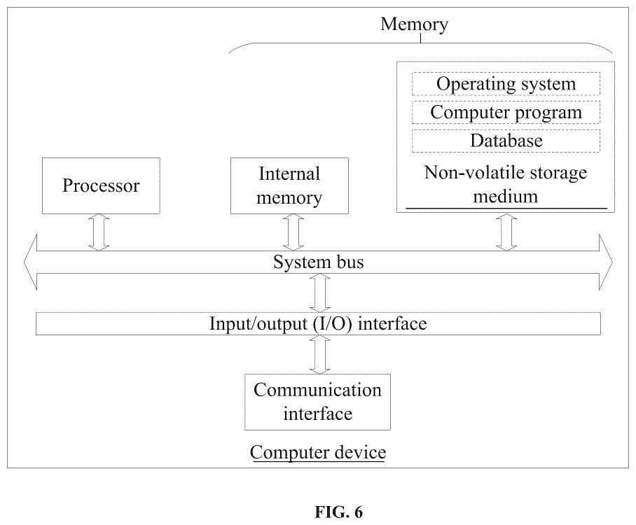

A computer apparatus is provided. The computer apparatus may be a database and can have an internal structure shown in FIG. 6. The computer apparatus includes a processor, a memory, an input/output (I/O) interface, and a communication interface. The processor, the memory, and the I/O interface are connected through a system bus, and the communication interface is connected to the system bus through the I/O interface. The processor of the computer apparatus is configured to provide computing and control capabilities. The memory of the computer apparatus includes a non-volatile storage medium and an internal memory. The non-volatile storage medium stores an operating system, a computer program, and a database. The internal memory provides an environment for operations of the operating system and the computer program in the non-volatile storage medium. The database of the computer apparatus is configured to store pending transactions. The I/O interface of the computer apparatus is configured to exchange information between the processor and an external apparatus. The communication interface of the computer apparatus is configured to communicate with an external terminal through a network. The computer program can be executed by a processor to implement steps of the method for determining a flood-diversion strategy of a flood storage and detention basin based on a balanced perspective in Example 1.

It should be noted that information of an object (including, but not limited to, apparatus information of the object, personal information of the object, or the like) and data (including, but not limited to, data for analysis, data for storage, data for display, or the like) in the present disclosure are information and data authorized by the object or fully authorized by each party, and the acquisition, use, and processing of relevant data need to comply with the relevant laws, regulations, and standards of relevant countries and regions.

Those of ordinary skill in the art may understand that all or some of the procedures in the method of the above embodiment may be implemented by a computer program commanding related hardware. The computer program may be stored in a non-volatile computer-readable storage medium. When the computer program is executed, the procedures in the embodiment of the above method may be implemented. Any reference to a memory, a database, or other media used in the embodiments of the present disclosure may include at least one selected from the group consisting of non-volatile and volatile memories. Non-volatile memories may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. Volatile memories may include a random access memory (RAM) or an external cache memory. As an illustration rather than a limitation, the RAM may be in various forms, such as a static random access memory (SRAM) or a dynamic random access memory (DRAM). The database involved in each embodiment provided by the present disclosure may include at least one selected from the group consisting of a relational database and a non-relational database. The non-relational database can include a block chain-based distributed database, but is not limited thereto. The processor involved in each embodiment provided by the present disclosure may be a general-purpose processor, a central processor, a graphic processor, a digital signal processor, a programmable logic device, or a quantum computing-based data processing logic device, but is not limited thereto.

The technical characteristics of the above embodiments can be arbitrarily combined. For brevity of description, not all possible combinations of the technical characteristics of the above embodiments are described. However, these combinations of the technical characteristics should be construed as falling within the scope defined by the specification as long as there is no contradiction among the combinations.

Specific embodiments are used herein to explain the principles and implementations of the present disclosure. The description of the embodiments is merely intended to help understand the method of the present disclosure and its core ideas. In addition, those of ordinary skill in the art can make various modifications to the specific implementations and application scope in accordance with the teachings of the present disclosure. In conclusion, the content of the present specification shall not be construed as a limitation to the present disclosure.

What is claimed is:

1. A method for determining a flood-diversion strategy of a flood storage and detention basin based on a balanced perspective, comprising:
determining excess flood peaks and excess flood amounts of middle and downstream main streams in a preset time period after scheduling and enabling of a reservoir group in each river section;
constructing a correlation map between a flood-diversion amount and a flood-diversion water-level reduction value under each set flood-diversion parameter combination;
determining enabling priorities and flood-diversion volumes for all flood storage and detention basins in all river sections;
according to an order of the enabling priorities, determining a cumulative flood-diversion volume of each flood storage and detention basin, wherein a cumulative flood-diversion volume of any current flood storage and detention basin is a sum of flood-diversion volumes of all flood storage and detention basins with a higher enabling priority than the current flood storage and detention basin and a flood-diversion volume of the current flood storage and detention basin;
based on the constructed correlation map and the determined cumulative flood-diversion volume of each flood storage and detention basin, constructing a flood storage and detention basin-enabling knowledge map;
based on the constructed flood storage and detention basin-enabling knowledge map, determining a plurality of flood-diversion plans each comprising a number of flood storage and detention basins enabled and a number of inputting days for each enabled flood storage and detention basin; and
based on an objective function and constraints, selecting a flood-diversion plan from the plurality of flood-diversion plans as a target plan to allow flood diversion, wherein the objective function is a minimum comprehensive disaster loss with respect to an enabled flood storage and detention basin, and the constraints are determined based on the excess flood amounts, the excess flood peaks, and water levels after flood diversion.

2. The method for determining a flood-diversion strategy of a flood storage and detention basin based on a balanced perspective according to claim 1, wherein the determining excess flood peaks and excess flood amounts of middle and downstream main streams in a preset time period after scheduling and enabling of a reservoir group in each river section comprises:
determining any reservoir in a reservoir group of any current river section as a current reservoir, and determining any time point in the preset time period as a current time point;
determining an uncontrolled-zone inflow rate and an inflow control station-measured flow rate for the current reservoir at the current time point;
based on the determined uncontrolled-zone inflow rate and the inflow control station-measured flow rate at the current time point, determining an inflow flood amount of the current reservoir at the current time point;
based on the determined inflow flood amount of the current reservoir at the current time point, determining an outflow flood amount of the current reservoir at the current time point by a reservoir-group flood-regulation model;
based on the determined outflow flood amounts of all reservoirs in the current river section at the current time point, determining a water-incoming boundary at the current time point;
based on the determined water-incoming boundary at the current time point, determining a pre-flood-diversion water level and a pre-flood-diversion flow rate of a main control station of the current river section at the current time point;
acquiring a safe discharge capacity of the current river section; and
based on the acquired safe discharge capacity and a pre-flood-diversion flow rate of the main control station of the current river section at each time point in the preset time period, calculating an excess flood peak and an excess flood amount of the current river section in the preset time period.

3. The method for determining a flood-diversion strategy of a flood storage and detention basin based on a balanced perspective according to claim 1, wherein the constructing a correlation map between a flood-diversion amount and a flood-diversion water-level reduction value under each set flood-diversion parameter combination comprises:
determining a plurality of set flood-diversion parameter combinations each comprising: a set flood-diversion flow rate, a number of set flood-diversion dates, and a set flood-diversion duration on each flood-diversion date;
determining the flood-diversion amount and the flood-diversion water-level reduction value under each set flood-diversion parameter combination, wherein the flood-diversion water-level reduction value is a water-level reduction value before and after flood diversion is conducted with the flood-diversion amount under each set flood-diversion parameter combination; and
based on all set flood-diversion parameter combinations and corresponding flood-diversion amounts and flood-diversion water-level reduction values, constructing the correlation map between the flood-diversion amount and the flood-diversion water-level reduction value under each set flood-diversion parameter combination.

4. The method for determining a flood-diversion strategy of a flood storage and detention basin based on a balanced perspective according to claim 3, wherein the determining the flood-diversion amount and the flood-diversion water-level reduction value under each set flood-diversion parameter combination comprises:
based on a set flood-diversion flow rate, a number of set flood-diversion dates, and a set flood-diversion duration on each flood-diversion date in each set flood-diversion parameter combination, calculating the flood-diversion amount under each set flood-diversion parameter combination; and
based on the flood-diversion amount under each set flood-diversion parameter combination, determining the flood-diversion water-level reduction value under each set flood-diversion parameter combination.

5. The method for determining a flood-diversion strategy of a flood storage and detention basin based on a balanced perspective according to claim 1, wherein the constraints comprise:
a cumulative flood-diversion volume of a flood storage and detention basin enabled in a flood-diversion plan is greater than or equal to an excess flood amount in the preset time period;
a flood-diversion capacity of a gate of a flood storage and detention basin enabled in a flood-diversion plan is greater than or equal to an excess flood peak in the preset time period; and
a water level after flood diversion using a flood-diversion plan is lower than a guaranteed water level.

6. The method for determining a flood-diversion strategy of a flood storage and detention basin based on a balanced perspective according to claim 2, wherein after the flood-diversion plan is selected from the plurality of flood-diversion plans as the target plan based on the objective function and the constraints to allow the flood diversion, the method further comprises:
based on a water level after flood diversion using the target plan and a water level before the flood diversion using the target plan, calculating a flood-diversion water-level reduction value of the target plan.

7. A computer device, comprising a memory, a processor, and a computer program stored in the memory and executable on the processor, wherein the processor executes the computer program to implement steps of the method for determining a flood-diversion strategy of a flood storage and detention basin based on a balanced perspective according to claim 1.

8. A non-transitory computer-readable storage medium in which a computer program is stored, wherein the computer program is executed by a processor to implement steps of the method for determining a flood-diversion strategy of a flood storage and detention basin based on a balanced perspective according to claim 1.

9. The computer device according to claim 7, wherein the determining excess flood peaks and excess flood amounts of middle and downstream main streams in a preset time period after scheduling and enabling of a reservoir group in each river section comprises:
determining any reservoir in a reservoir group of any current river section as a current reservoir, and determining any time point in the preset time period as a current time point;
determining an uncontrolled-zone inflow rate and an inflow control station-measured flow rate for the current reservoir at the current time point;
based on the determined uncontrolled-zone inflow rate and the inflow control station-measured flow rate at the current time point, determining an inflow flood amount of the current reservoir at the current time point;
based on the determined inflow flood amount of the current reservoir at the current time point, determining an outflow flood amount of the current reservoir at the current time point by a reservoir-group flood-regulation model;
based on the determined outflow flood amounts of all reservoirs in the current river section at the current time point, determining a water-incoming boundary at the current time point;
based on the determined water-incoming boundary at the current time point, determining a pre-flood-diversion water level and a pre-flood-diversion flow rate of a main control station of the current river section at the current time point;
acquiring a safe discharge capacity of the current river section; and
based on the acquired safe discharge capacity and a pre-flood-diversion flow rate of the main control station of the current river section at each time point in the preset time period, calculating an excess flood peak and an excess flood amount of the current river section in the preset time period.

10. The computer device according to claim 7, wherein the constructing a correlation map between a flood-diversion amount and a flood-diversion water-level reduction value under each set flood-diversion parameter combination comprises:
determining a plurality of set flood-diversion parameter combinations each comprising: a set flood-diversion flow rate, a number of set flood-diversion dates, and a set flood-diversion duration on each flood-diversion date;
determining the flood-diversion amount and the flood-diversion water-level reduction value under each set flood-diversion parameter combination, wherein the flood-diversion water-level reduction value is a water-level reduction value before and after flood diversion is conducted with the flood-diversion amount under each set flood-diversion parameter combination; and
based on all set flood-diversion parameter combinations and corresponding flood-diversion amounts and flood-diversion water-level reduction values, constructing the correlation map between the flood-diversion amount and the flood-diversion water-level reduction value under each set flood-diversion parameter combination.

11. The computer device according to claim 10, wherein the determining the flood-diversion amount and the flood-diversion water-level reduction value under each set flood-diversion parameter combination comprises:
based on a set flood-diversion flow rate, a number of set flood-diversion dates, and a set flood-diversion duration on each flood-diversion date in each set flood-diversion parameter combination, calculating the flood-diversion amount under each set flood-diversion parameter combination; and
based on the calculated flood-diversion amount under each set flood-diversion parameter combination, determining the flood-diversion water-level reduction value under each set flood-diversion parameter combination.

12. The computer device according to claim 7, wherein the constraints comprise:
a cumulative flood-diversion volume of a flood storage and detention basin enabled in a flood-diversion plan is greater than or equal to an excess flood amount in the preset time period;
a flood-diversion capacity of a gate of a flood storage and detention basin enabled in a flood-diversion plan is greater than or equal to an excess flood peak in the preset time period; and
a water level after flood diversion using a flood-diversion plan is lower than a guaranteed water level.

13. The computer device according to claim 9, wherein after the flood-diversion plan is selected from the plurality of flood-diversion plans as the target plan based on the objective function and the constraints to allow the flood diversion, the method further comprises:
based on a water level after flood diversion using the target plan and a water level before the flood diversion using the target plan, calculating a flood-diversion water-level reduction value of the target plan.

14. The non-transitory computer-readable storage medium according to claim 8, wherein the determining excess flood peaks and excess flood amounts of middle and downstream main streams in a preset time period after scheduling and enabling of a reservoir group in each river section comprises:
determining any reservoir in a reservoir group of any current river section as a current reservoir, and determining any time point in the preset time period as a current time point;
determining an uncontrolled-zone inflow rate and an inflow control station-measured flow rate for the current reservoir at the current time point;
based on the uncontrolled-zone inflow rate and the inflow control station-measured flow rate at the current time point, determining an inflow flood amount of the current reservoir at the current time point;
based on the determined inflow flood amount of the current reservoir at the current time point, determining an outflow flood amount of the current reservoir at the current time point by a reservoir-group flood-regulation model;
based on the determined outflow flood amounts of all reservoirs in the current river section at the current time point, determining a water-incoming boundary at the current time point;
based on the determined water-incoming boundary at the current time point, determining a pre-flood-diversion water level and a pre-flood-diversion flow rate of a main control station of the current river section at the current time point;
acquiring a safe discharge capacity of the current river section; and
based on the acquired safe discharge capacity and a pre-flood-diversion flow rate of the main control station of the current river section at each time point in the preset time period, calculating an excess flood peak and an excess flood amount of the current river section in the preset time period.

15. The non-transitory computer-readable storage medium according to claim 8, wherein the constructing a correlation map between a flood-diversion amount and a flood-diversion water-level reduction value under each set flood-diversion parameter combination comprises:
determining a plurality of set flood-diversion parameter combinations each comprising: a set flood-diversion flow rate, a number of set flood-diversion dates, and a set flood-diversion duration on each flood-diversion date;
determining the flood-diversion amount and the flood-diversion water-level reduction value under each set flood-diversion parameter combination, wherein the flood-diversion water-level reduction value is a water-level reduction value before and after flood diversion is conducted with the flood-diversion amount under each set flood-diversion parameter combination; and
based on all set flood-diversion parameter combinations and corresponding flood-diversion amounts and flood-diversion water-level reduction values, constructing the correlation map between the flood-diversion amount and the flood-diversion water-level reduction value under each set flood-diversion parameter combination.

16. The non-transitory computer-readable storage medium according to claim 15, wherein the determining the flood-diversion amount and the flood-diversion water-level reduction value under each set flood-diversion parameter combination comprises:
based on a set flood-diversion flow rate, a number of set flood-diversion dates, and a set flood-diversion duration on each flood-diversion date in each set flood-diversion parameter combination, calculating the flood-diversion amount under each set flood-diversion parameter combination; and
based on the flood-diversion amount under each set flood-diversion parameter combination, determining the flood-diversion water-level reduction value under each set flood-diversion parameter combination.

17. The non-transitory computer-readable storage medium according to claim 8, wherein the constraints comprise:
a cumulative flood-diversion volume of a flood storage and detention basin enabled in a flood-diversion plan is greater than or equal to an excess flood amount in the preset time period;
a flood-diversion capacity of a gate of a flood storage and detention basin enabled in a flood-diversion plan is greater than or equal to an excess flood peak in the preset time period; and
a water level after flood diversion using a flood-diversion plan is lower than a guaranteed water level.

18. The non-transitory computer-readable storage medium according to claim 14, wherein after the flood-diversion plan is selected from the plurality of flood-diversion plans as the target plan based on the objective function and the constraints to allow the flood diversion, the method further comprises:
based on a water level after flood diversion using the target plan and a water level before the flood diversion using the target plan, calculating a flood-diversion water-level reduction value of the target plan.
